(19) United States
(12) Patent Application Publication
(10) Pub. No.: US 2020/0218289 A1
(43) Pub. Date: Jul. 9, 2020

(54) INFORMATION PROCESSING APPARATUS, AERIAL PHOTOGRAPHY PATH GENERATION METHOD, PROGRAM AND RECORDING MEDIUM

(71) Applicant: SZ DJI TECHNOLOGY CO., LTD., Shenzhen (CN)

(72) Inventors: Lei GU, Shenzhen (CN); Bin CHEN, Shenzhen (CN)

(21) Appl. No.: 16/821,641

(22) Filed: Mar. 17, 2020

Related U.S. Application Data
(63) Continuation of application No. PCT/CN2018/110855, filed on Oct. 18, 2018.

(30) Foreign Application Priority Data
Oct. 24, 2017 (JP) 2017-205392

(51) Int. Cl. G05D 1/10; G05D 1/00; G08G 5/00; B64C 39/02; G06T 7/73

(52) U.S. Cl. CPC G05D 1/106; G05D 1/0094; G08G 5/0086; G06T 2210/12; G06T 7/74; B64C 2201/123; B64C 39/024

(57) ABSTRACT

An information processing apparatus for generating an aerial photography path for aerial photography by an aircraft is provided. The information processing apparatus includes a processing unit for performing processes related to generating the aerial photography path. The processing unit is configured to acquire terrain information of an aerial photography area, divide the aerial photography area at each height above ground level in the aerial photography area to generate a plurality of zones, generate a first aerial photography path for aerial photography in each generated zone, and connect the generated first aerial photography path for each generation zone to generate a second aerial photography path for capturing aerial photographs in the aerial photography area.

### CROSS-REFERENCE TO RELATED APPLICATION

This application is a continuation of International Application No. PCT/CN2018/110855, filed on Oct. 18, 2018, which claims priority to Japanese Application No. 2017-205392, filed on Oct. 24, 2017, the entire contents of all of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of unmanned aerial vehicle technology and, more particularly, to an information processing apparatus, aerial photography path generation method, program and recoding medium thereof.

### BACKGROUND

Conventionally, a platform (e.g., an unmanned aerial vehicle) that captures photographs through a predefined fixed path is already known. The platform accepts photography instructions from the ground base station and captures photographs for targeted objects. When capturing photographs for targeted objects, the platform flies on a fixed path on one side. On the other side, the platform tilts the photography device to capture photographs based on the position relationship between the platform and the targeted objects.

Among the objects photographed by an unmanned aerial vehicle (UAV), there are objects (e.g., mountains, artificial buildings (such as dams, oil platforms, buildings)) in which there is a height difference. There is also a need for aerial photography of an object having a difference in height. However, when capturing aerial photographs of an object having a height difference using a device described in the patent document for Japanese Application No. 2010-61216, since the flying height is fixed when the aerial photography is performed, the distance from the UAV to the object may be different for different parts of the object. Therefore, the image quality of aerial photographs obtained by aerial photography of the UAV likely decreases. Furthermore, when a composite image or a stereo image is generated based on the aerial photographs, the image quality of the composite image or the stereo image also likely decreases.

### SUMMARY

In accordance with the present disclosure, there is provided an information processing apparatus for generating an aerial photography path for aerial photography by an aircraft. The information processing apparatus includes a processing unit for performing processes related to generating the aerial photography path. The processing unit is configured to acquire terrain information of an aerial photography area, divide the aerial photography area at each height above ground level in the aerial photography area to generate a plurality of zones, generate a first aerial photography path for aerial photography in each generated zone, and connect the generated first aerial photography path for each generation zone to generate a second aerial photography path for capturing aerial photographs in the aerial photography area.

Also in accordance with the disclosure, there is provided an aerial photography path generation method. The method is applied to an information processing apparatus for generating an aerial photography path for aerial photography by an aircraft. The method includes acquiring terrain information in the aerial photography area, dividing the aerial photography area at each height above ground level in the aerial photography area to generate a plurality of zones, generating a first aerial photography path for aerial photography in each of the plurality of zones, and connecting the first aerial photography path in each of the plurality of zones to generate a second aerial photography path for aerial photography in the aerial photography area.

### BRIEF DESCRIPTION OF THE DRAWINGS

FIG. 1 is a schematic diagram illustrating one example configuration of an aerial photography path generation system according to an embodiment of the present disclosure.

FIG. 2 is a schematic diagram illustrating another example configuration of an aerial photography path generation system according to an embodiment of the present disclosure.

FIG. 3 is a block diagram illustrating an example hardware configuration of an unmanned aerial vehicle according to an embodiment of the present disclosure.

FIG. 4 is a block diagram illustrating an example hardware configuration of a terminal according to an embodiment of the present disclosure.

FIG. 5 is a schematic diagram illustrating an example contour zone in accordance with one height above ground level according to an embodiment of the present disclosure.

FIG. 6 is a schematic diagram illustrating an example axis-aligned bounding box surrounding a contour zone according to an embodiment of the present disclosure.

FIG. 7 is a schematic diagram illustrating one example of an aerial photography path in an axis-aligned bounding box according to an embodiment of the present disclosure.

FIG. 8 is a schematic diagram illustrating a continued example of FIG. 7 for an aerial photography path in an axis-aligned bounding box according to an embodiment of the present disclosure.

FIG. 9 is a schematic diagram illustrating another example of an aerial photography path in an axis-aligned bounding box according to an embodiment of the present disclosure.

FIG. 10 is a flowchart illustrating an example method of a terminal operation according to an embodiment of the present disclosure.

FIG. 11 is a schematic diagram illustrating a frequent change of photographing height in an aerial photograph path in a comparative example according to an embodiment of the present disclosure.

FIG. 12 is a flowchart illustrating an operation example of an unmanned aerial vehicle according to an embodiment of the present disclosure.

FIG. 13A is a schematic diagram illustrating one example of a right-angled polygon frame surrounding a contour zone according to an embodiment of the present disclosure.

FIG. 13B is a schematic diagram illustrating another example of a right-angled polygon frame surrounding a contour zone according to an embodiment of the present disclosure.

FIG. 14 is a schematic diagram illustrating a case in which a contour zone having an equal height is recognized as one zone according to an embodiment of the present disclosure.

### DETAILED DESCRIPTION OF THE EMBODIMENTS

The present disclosure will be made in detail hereinafter with specific embodiments. It is to be understood that the illustrated embodiments are not intended to limit the disclosure related to the claims. All the features and the combinations thereof described in the embodiments are not necessarily required for the technical solutions of the present disclosure.

In the following embodiments, a UAV is illustrated as an example of the information processing apparatus. A UAV is an example of an aircraft, including an aircraft moving in the air. In the drawings accompanying the specification, unmanned aircraft is also referred to as “UAV”. The information processing apparatus may be also a device other than a UAV. For instance, the information processing apparatus may be a terminal, a PC (Personal Computer), or another device. The aerial photography path generation method is to manipulate operations in the information processing apparatus. The recording medium stores a program (e.g., a program that causes the information processing apparatus to execute various processing).

### Embodiment 1

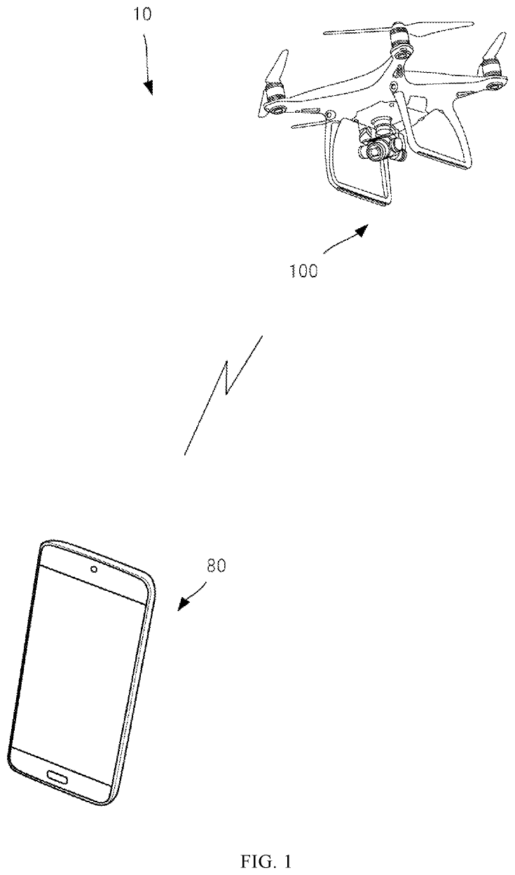

FIG. 1 is a schematic diagram illustrating an example configuration of an aerial photography path generation system 10 in Embodiment 1. The aerial photography path generation system 10 includes a UAV 100 and a terminal 80. The UAV 100 and the terminal 80 may communicate with each other through wired or wireless communication (e.g., a wireless LAN (Local Area Network)). In FIG. 1, the terminal 80 may be a mobile terminal (e.g., a smart phone or tablet).

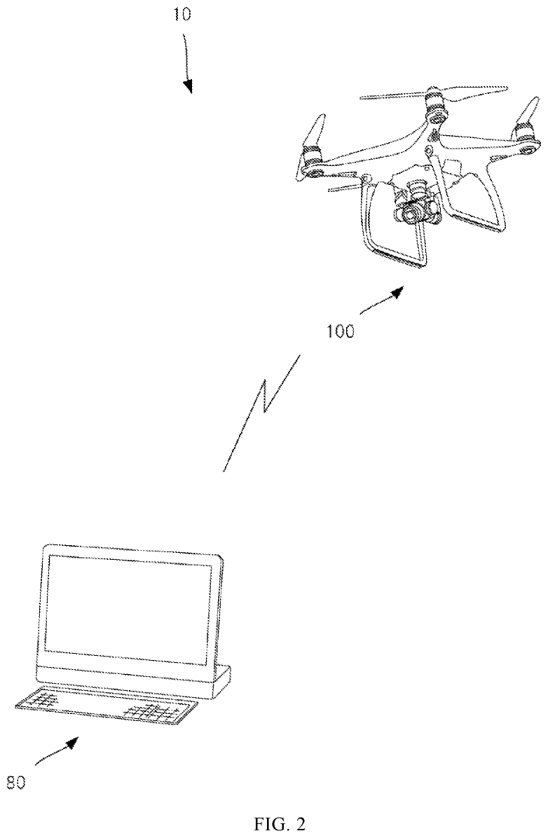

FIG. 2 is a schematic diagram illustrating another example configuration of the aerial photography path generation system 10 in Embodiment 1. FIG. 2 illustrates an example in which the terminal 80 is a PC. In FIG. 1 and FIG. 2, the terminal 80 may have the same functions.

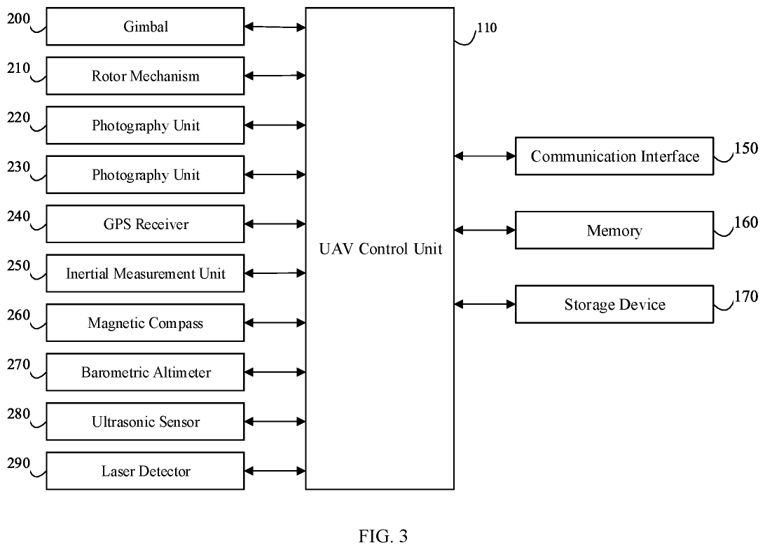

FIG. 3 is a block diagram illustrating an example of a hardware configuration of the UAV 100. The structure of the UAV 100 includes a UAV control unit 110, a communication interface 150, a memory 160, a storage device 170, a gimbal 200, a rotor mechanism 210, a photography unit 220, a photography unit 230, a GPS receiver 240, an inertial measurement unit (IMU) 250, a magnetic compass 260, a barometric altimeter 270, a ultrasonic sensor 280, and a laser detector 290.

The UAV control unit 110 may be, for example, a CPU (Central Processing Unit), an MPU (Micro Processing Unit), or a DSP (Digital Signal Processor). The UAV control unit 110 is configured to control the operation of each component of the UAV 100 in signal processing, data input/output processing with other components, data calculation processing, and data storage processing.

The UAV control unit 110 controls the flight of the UAV 100 in accordance with a program stored in the memory 160. The UAV control unit 110 may control the flight according to an aerial photography path generated by the terminal 80 or the UAV 100. The UAV control unit 110 may capture photographs in the air according to the aerial photography positions generated by the terminal 80 or the UAV 100. Here, aerial photography is just one example of photography.

The UAV control unit 110 acquires position information indicating the position of the UAV 100. The UAV control unit 110 may acquire the position information indicating the latitude, longitude, and altitude of the UAV 100 from the GPS receiver 240. The UAV control unit 110 may acquire the latitude and longitude information indicating the latitude and longitude at which the UAV 100 is located from the GPS receiver 240 as a part of the position information, and acquire the altitude information indicating the altitude at which the UAV 100 is located from the barometric altimeter 270 as a part of the position information. The UAV control unit 110 may also acquire a distance between an ultrasonic radiation point and an ultrasonic reflection point of the ultrasonic sensor 280 as the height information.

The UAV control unit 110 may acquire orientation information indicating the flying direction of the UAV 100 from the magnetic compass 260. The orientation information may be expressed, for example, in an azimuth corresponding to the nose direction of the UAV 100.

The UAV control unit 110 may acquire the position information indicating a position(s) at which the UAV 100 should be located when the photography unit 220 captures photographs within a to-be-photographed area. The UAV control unit 110 may acquire the position information, indicating the position(s) where the UAV 100 should be located, from the memory 160. The UAV control unit 110 may acquire the position information indicating the position(s) where the UAV 100 should be located from another device via the communication interface 150. The UAV control unit 110 may refer to a three-dimensional map database to determine a position where the UAV 100 should be located, and then acquire that position indicating where the UAV 100 should be located as the position information.

The UAV control unit 110 may acquire the photography area information indicating the photography areas of the photography unit 220 and the photography unit 230. The UAV control unit 110 may acquire the angle of view information indicating the angles of view of the photography unit 220 and the photography unit 230 from the photography unit 220 and the photography unit 230 as the parameters for determining the photography areas. The UAV control unit 110 may acquire information indicating the photography directions of the photography unit 220 and the photography unit 230 as the parameters for determining the photography areas. The UAV control unit 110 may acquire posture information indicating the posture of the photography unit 220 from the gimbal 200 as, for example, information indicating the photography direction of the photography unit 220. The posture information of the photography unit 220 may indicate rotation angles of the pitch axis and the yaw axis of the gimbal 200 relative to the reference rotation angle.

The UAV control unit 110 may acquire the position information indicating the location of the UAV 100 as parameters for determining a photography area. Based on the angles of view and the photography directions of the photography unit 220 and the photography unit 230 and the location of the UAV 100, the UAV control unit 110 may define the photography areas indicating the geographic areas to be photographed by the photography unit 220 and the photography unit 230, and generate the photography area information. In this way, the photography area information may be obtained.

The UAV control unit 110 may acquire the photography area information from the memory 160, or through the communication interface 150.

The UAV control unit 110 controls the gimbal 200, the rotor mechanism 210, the photography unit 220, and the photography unit 230. The UAV control unit 110 may control the photography area of the photography unit 220 by changing the photography direction or angle of view of the photography unit 220. The UAV control unit 110 may control the photography area of the photography unit 220 supported by the gimbal 200 by controlling the rotation mechanism of the gimbal 200.

A photography area refers to a geographic area to be photographed by the photography unit 220 or the photography unit 230. The photography area is defined by latitude, longitude, and altitude. The photography area may be an area in three-dimensional space data defined by latitude, longitude, and altitude. The photography area may also be an area in two-dimensional space data defined by latitude and longitude. The photography area may be determined based on the angle of view and photography direction of the photography unit 220 or the photography unit 230 and the location of the UAV 100. The photography directions of the photography unit 220 and the photography unit 230 may be defined according to the orientation and depression angles of the front surfaces of the photography unit 220 and the photography unit 230 equipped with an imaging lens. The photography direction of the photography unit 220 may be a direction determined according to the nose position of the UAV 100 and the posture state of the photography unit 220 with respect to the gimbal 200. The photography direction of the photography unit 230 may be a direction determined according to the nose position of the UAV 100 and the position where the photography unit 230 is disposed.

The UAV control unit 110 may determine the surrounding environment of the UAV 100 by analyzing a plurality of photographs captured by a plurality of photography units 230. The UAV control unit 110 may control the flight, such as avoiding obstacles, based on the surrounding environment of the UAV 100.

The UAV control unit 110 may acquire stereoscopic information (three-dimensional information) indicating a stereoscopic shape (three-dimensional shape) of an object existing around the UAV 100. The object may be part of a landscape such as a building, a road, a vehicle, a tree, or the like. The stereoscopic information includes, for example, three-dimensional space data. The UAV control unit 110 may acquire stereoscopic information by generating stereoscopic information indicating a stereoscopic shape of an object existing around the UAV 100 based on each photograph obtained from the plurality of photography units 230. The UAV control unit 110 may acquire three-dimensional information indicating a three-dimensional shape of an object existing around the UAV 100 by referring to a three-dimensional map database stored in the memory 160 or the storage device 170. The UAV control unit 110 may acquire stereoscopic information related to the stereoscopic shape of an object existing around the UAV 100 by referring to a three-dimensional map database managed by a server existing on the network.

The UAV control unit 110 controls the flight of the UAV 100 by controlling the rotor mechanism 210. That is, the UAV control unit 110 controls the position including the latitude, longitude, and altitude of the UAV 100 by controlling the rotor mechanism 210. The UAV control unit 110 may control the photography area of the photography unit 220 by controlling the flight of the UAV 100. The UAV control unit 110 may control the angle of view of the photography unit 220 by controlling a zoom lens included in the photography unit 220. The UAV control unit 110 may use the digital zoom function of the photography unit 220 to control the angle of view of the photography unit 220 through digital zoom.

When the photography unit 220 is fixed to the UAV 100 and the photography unit 220 is not activated, the UAV control unit 110 may navigate the UAV 100 to a specified position at a specified time, to allow the photography unit 220 to capture photographs within a desired photography area in a desired environment. Alternatively, even if the photography unit 220 does not have a zoom function and the angle of view of the photography unit 220 cannot be changed, the UAV control unit 110 may still navigate the UAV 100 to a specified position at a specified time, to allow the photography unit 220 to capture photographs within a desired photography area in a desired environment.

The communication interface 150 communicates with the terminal 80. The communication interface 150 may perform wireless communication using any wireless communication method. The communication interface 150 may perform wired communication using any wired communication method. The communication interface 150 may transmit an aerial photograph or additional information (metadata) related to the aerial photograph to the terminal 80.

The memory 160 stores programs required by the UAV control unit 110 to control the gimbal 200, the rotor mechanism 210, the photography unit 220, the photography unit 230, the GPS receiver 240, the inertial measurement device 250, the magnetic compass 260, the barometric altimeter 270, the ultrasonic sensor 280, and the laser detector 290. The memory 160 may be a computer-readable recording medium, or may include at least one of SRAM (Static Random-Access Memory), DRAM (Dynamic Random-Access Memory), and EPROM (Erasable Programmable Read-Only Memory), EEPROM (Electrically Erasable Programmable Read-Only Memory), and USB (Universal Serial Bus) and other flash drives. The memory 160 may also be detachable from the UAV 100. The memory 160 may run as a working memory.

The storage device 170 may include at least one of a hard disk drive (HDD), a solid-state drive (SSD), an SD card, a USB memory, and other memories. The storage device 170 may store various information and various data. The storage device 170 may also be detachable from the UAV 100. The storage device 170 may store aerial photographs or additional information thereof.

The memory 160 or the storage device 170 may store information of aerial photography positions or an aerial photography path generated by the terminal 80 or the UAV 100. The information of the aerial photography positions or the aerial photography path may include the aerial photography parameters related to aerial photography predefined by the UAV 100 or the flight-related flight parameters predefined by the UAV 100, and may be defined by the UAV control unit 110. The defined information may be stored in the memory 160 or the storage device 170.

The gimbal 200 may support the photography unit 220 to allow the photography unit 220 to rotate around the yaw axis, the pitch axis, and the roll axis. The gimbal 200 may change the photography direction of the photography unit 220 by rotating the photography unit 220 around at least one of the yaw axis, the pitch axis, and the roll axis.

The yaw axis, pitch axis, and roll axis may be defined as follows. In one example, the roll axis may be defined as a horizontal direction (i.e., a direction parallel to the ground). Based on that, the pitch axis is then defined as a direction also parallel to the ground but is perpendicular to the roll axis. The yaw axis (which may be also referred to the z axis) is defined as a direction perpendicular to the ground and also perpendicular to the roll axis and the pitch axis.

The rotor mechanism 210 includes a plurality of rotors and a plurality of motor drives that rotate the plurality of rotors. The rotor mechanism 210 rotates under the control of the UAV control unit 110, to drive the UAV 100 to fly. The number of rotors 211 may be, for example, four, or another number. In some embodiments, the UAV 100 may be a fixed-wing aircraft without a rotor.

The photography unit 220 may be a photography camera that captures an object (such as a scene of the sky, a landscape such as a mountain or a river, or a building on the ground, which may serve as an aerial photography target) located within a desired photography area. The photography unit 220 captures a to-be-photographed object in the desired photography area, and generates photography image data. The image data (e.g., aerial photographs) obtained by the photography unit 220 may be stored in the memory 160 or the storage device 170 included in the photography unit 220.

A photography unit 230 may be a sensing camera that captures the surroundings of the UAV 100 to control the flight of the UAV 100. Two photography units 230 may be disposed on the front side (i.e., the nose) of the UAV 100. Further, two additional photography units 230 may be disposed on the bottom surface of the UAV 100. The two photography units 230 on the front side may form a pair and function as a so-called stereo camera. The two photography units 230 on the bottom side may also form a pair and function as a stereo camera. The three-dimensional space data (i.e., three-dimensional shape data) around the UAV 100 may be generated based on the photographs obtained by the plurality of photography units 230. The number of photography units 230 included in the UAV 100 is not limited to four. The UAV 100 may include at least one photography unit 230, or the UAV 100 may include at least one photography unit 230 on each of the nose, tail, side, bottom, and top surfaces of the UAV 100. The angle of view configured for a photography unit 230 may be greater than the angle of view configured for a photography unit 220. A photography unit 230 may include a fixed focus lens or a fisheye lens. The photography units 230 capture the surroundings of the UAV 100 and generate photography image data. The image data of the photography units 230 may be stored in the storage device 170.

The GPS receiver 240 receives a plurality of signals indicating the time that the signals are transmitted from a plurality of navigation satellites (i.e., GPS satellites) and the position (coordinates) of each GPS satellite. The GPS receiver 240 calculates the position of the GPS receiver 240 (i.e., the position of the UAV 100) based on the received plurality of signals. The GPS receiver 240 outputs the position information of the UAV 100 to the UAV control unit 110. The calculation of the position information of the GPS receiver 240 may be performed by the UAV control unit 110 instead of the GPS receiver 240. Accordingly, the information, including the time and the position of each GPS satellite included in the plurality of signals received by the GPS receiver 240, is then input into the UAV control unit 110.

The inertial measurement device 250 detects the posture of the UAV 100 and outputs the detected result to the UAV control unit 110. Beside the posture of the UAV 100, the inertial measurement device 250 may also detect the acceleration of the UAV 100 in the three directions (i.e., the front-rear, left-right, and up-down directions) and the angular velocities of the pitch axis, roll axis, and yaw axis.

The magnetic compass 260 detects the nose position of the UAV 100 and outputs the detected result to the UAV control unit 110.

The barometric altimeter 270 detects the flying altitude of the UAV 100 and outputs the detected result to the UAV control unit 110.

The ultrasonic sensor 280 emits an ultrasonic wave, detects the ultrasonic wave reflected by the ground or an object, and outputs the detected result to the UAV control unit 110. The detected result may indicate the distance from the UAV 100 to the ground, that is, the height. The detection result may also indicate the distance from the UAV 100 to an object (e.g., a to-be-photographed object).

The laser detector 290 irradiates a laser beam to an object, receives the reflection light reflected by the object, and uses the reflection light to measure the distance between the UAV 100 and the object (i.e., a to-be-photographed object). As an example, the distance measurement method of the laser may be a time-of-flight method.

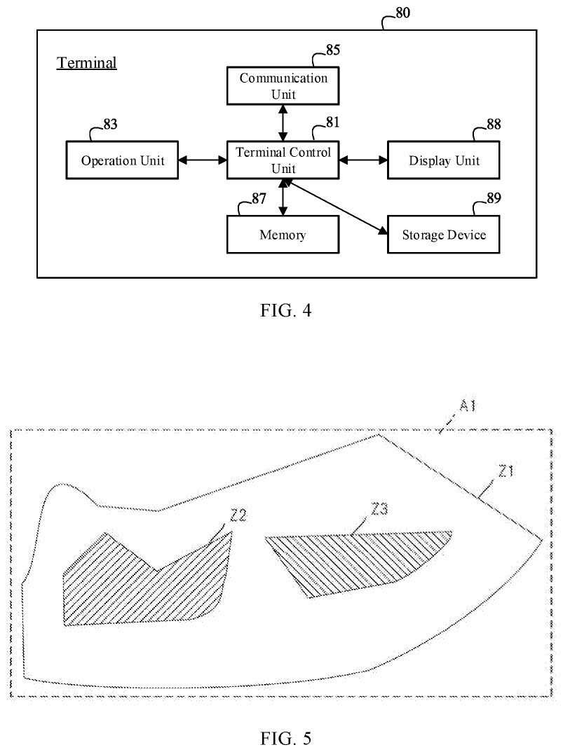

FIG. 4 is a block diagram illustrating an example of a hardware configuration of the terminal 80. The terminal 80 may include a terminal control unit 81, an operation unit 83, a communication unit 85, a memory 87, a display unit 88, and a storage device 89. The terminal 80 may be held by a user who wants to generate an aerial photography path.

The terminal control unit 81 may be, for example, a CPU, an MPU, or a DSP. The terminal control unit 81 is configured to control the operation of each component of the control terminal 80 in signal processing, data input/output processing with other components, data calculation processing, and data storage processing.

The terminal control unit 81 may acquire data, aerial photographs, or other information from the UAV 100 via the communication unit 85. The terminal control unit 81 may acquire data or information (e.g., various parameters such as flight parameters or aerial photography parameters) input through the operation unit 83. The terminal control unit 81 may acquire data, aerial photographs, or information stored in the memory 87. The terminal control unit 81 may transmit data or information (e.g., information on the generated aerial photography positions and aerial photography path) to the UAV 100 via the communication unit 85. The terminal control unit 81 may transmit data, information, or aerial photographs to the display unit 88, to allow the display unit 88 to display information based on the data, information, or aerial photographs.

The terminal control unit 81 may execute an application for generating an aerial photography path or an application for supporting the generation of an aerial photography path. The terminal control unit 81 may generate various data used in the application.

The operation unit 83 receives and acquires data or information input by a user of the terminal 80. The operation unit 83 may include buttons, keys, a touch screen, a microphone, and the like. In some embodiments, the operation unit 83 and the display unit 88 includes a situation in which there is a touch panel. In such a situation, the operation unit 83 may accept a touch operation, a tap operation, a drag operation, and the like. The operation unit 83 may receive various parameter information. The information input by the operation unit 83 may be transmitted to the UAV 100. The various parameters may include parameters related to the generation of an aerial photography path (e.g., at least one of the flight parameters or aerial photography parameters of the UAV 100 when capturing aerial photographs along the aerial photography path).

The communication unit 85 performs wireless communication with the UAV 100 using various wireless communication methods. The wireless communication methods may include, for example, communication via a wireless LAN, Bluetooth®, or public wireless communication, etc. The communication unit 85 may perform wired communication using any wired communication method.

The memory 87 may include, for example, a ROM that stores a program or predefined value data that manipulates the terminal 80 operation, and a RAM that temporarily stores various information or data used by the terminal control unit 81 for processing. The memory 87 may include a memory other than ROM and RAM. The memory 87 may be disposed inside the terminal 80, or may be detachable from the terminal 80. The program may include an application program.

The display unit 88 may include, for example, an LCD (Liquid Crystal Display), and is configured to display various information, data, or aerial photographs output from the terminal control unit 81. The display unit 88 may display various data or information associated with the execution of an application.

The storage device 89 saves and stores various data and information. The storage device 89 may be an HDD, SSD, SD card, USB memory, or the like. The storage device 89 may be disposed inside the terminal 80, or may be detachable from the terminal 80. The storage device 89 may store aerial photographs or additional information acquired from the UAV 100. The additional information may also be stored in the memory 87.

Next, specific functions related to generating an aerial photography path will be described. Here, the functions related to generating an aerial photography path will be described mainly with reference to the terminal control unit 81 of the terminal 80. However, the UAV 100 may also have functions related to generating an aerial photography path. The terminal control unit 81 is an example of the processing unit. The terminal control unit 81 performs a processing regarding the generation of an aerial photography path.

The terminal control unit 81 acquires aerial photography parameters when the photography unit 230 or the photography unit 230 included in the UAV 100 captures aerial photographs. The terminal control unit 81 may acquire aerial photography parameters from the memory 87. The terminal control unit 81 may accept a user operation via the operation unit 83 to acquire aerial photography parameters. The terminal control unit 81 may acquire the aerial photography parameters from other devices via the communication unit 85.

The aerial photography parameters may include at least one of aerial photography angle information, aerial photography direction information, aerial photography posture information, photography area information, distance information of a to-be-photographed object, and other information (such as resolution, image coverage, and repetition rate information).

The aerial photography angle information is field of view (FOV) information indicating the angle of view of the photography unit 220 or the photography unit 230 when an aerial photograph is captured in the air. The aerial photography direction information indicates the photography direction (i.e., aerial photography direction) of the photography unit 220 or the photography unit 230 when an aerial photograph is captured in the air. The aerial photography posture information indicates the posture of the photography unit 220 or the photography unit 230 when an aerial photograph is captured in the air. The photography area information indicates the photography area of the photography unit 220 or the photography unit 230 when an aerial photograph is captured in the air, and may be determined based on, for example, the rotation angle of the gimbal 200.

The distance information of a to-be-photographed object includes information indicating the distance from the photography unit 220 or the photography unit 230 to the object when an aerial photograph is captured in the air. The object may be the ground. In such a situation, the distance from the photography unit 220 or the photography unit 230 to the object is the distance from the ground to the photography unit 220 or the photography unit 230. That is, the distance is consistent with the flying height of the UAV 100. Therefore, distance information of the to-be-photographed object may be the flying height information of the UAV 100 when an aerial photograph is captured in the air. Further, beside the object distance information, the terminal control unit 81 may use other means to acquire the flying height information of the UAV 100 as one of the flight parameters when an aerial photograph is captured.

The terminal control unit 81 acquires an aerial photography area A1. The aerial photography area A1 is an area in which aerial photographs are captured by the UAV 100. The terminal control unit 81 may acquire the aerial photography area A1 from the memory 87 or an external server. The terminal control unit 81 may acquire the aerial photography area A1 via the operation unit 83. The operation unit 83 may accept a user input of a desired area for aerial photography, shown in the map information acquired from a map database or the like, as the aerial photography area A1. Further, the operation unit 83 may also allow input of a desired place name for which the aerial photography is expected, a building for identifying a place, or other name information (which may be referred to as place names), etc. Accordingly, the terminal control unit 81 may acquire either an area exactly indicated by a place name or a specified area surrounding a place name (e.g., an area within a radius of 100 m from a location indicated by the place name) as the aerial photography area A1.

The terminal control unit 81 then acquires terrain information in the aerial photography area A1. The terrain information may be information representing a three-dimensional shape (latitude, longitude, altitude) of the ground. The terminal control unit 81 may acquire the terrain information from the memory 87 or an external server. The terrain information may include information of an elevation map, a DEM (Digital Elevation Model), or a three-dimensional map stored in a map database, etc.

The terminal control unit 81 may calculate contour lines in the aerial photography area Al based on the terrain information in the aerial photography area A1, and generate a contour map. A contour map represents a collection of points that have a same height, and reflects ground fluctuations such as the tops of mountains or valleys. An area covered by a contour line may be referred to as a contour zone. A contour zone may be an area with the same height across all positions (e.g., an area with a height of 10 m), an area with each height falling within a certain range (e.g., an area with a height of 10 m to 20 m), or an area with each height greater than a threshold thl (e.g., an area having a height of 10 m or more).

FIG. 5 is a schematic diagram illustrating an example of a contour zone according to the height above ground level. FIG. 5 is a view of the ground viewed from the top. In FIG. 5, the aerial photography area A1 includes contour zones Z1, Z2, and Z3. The contour zone Z1 may be, for example, lower than the contour zones Z2 and Z3. The heights of the contour zones Z2 and Z3 may be the same or different. The relationship between the heights here is merely an example, and other relationships may also be possible. In addition, the outer periphery of the aerial photography area A1 may coincide with the outer periphery of the outermost contour zone Z1.

In addition, the zones divided by each height above ground level are represented by contour zones Z1 to Z3 in FIG. 5. However, these zones may also be directly derived (e.g., calculated) from the terrain information in the aerial photography area A1. In this way, the calculation of the contour lines and the generation of the contour map may be omitted.

The terminal control unit 81 divides the aerial photography area A1 at each height above ground level in the aerial photography area A1 to generate a plurality of zones (i.e., divided zones). Each zone becomes a unit of an area for generating an aerial photography path. The aerial photography paths in the plurality of zones are connected to generate an overall aerial photography path. The terminal control unit 81 may divide each area having the same height above ground level into one zone. The terminal control unit 81 may divide these zones based on, for example, the contour lines or contour map.

The terminal control unit 81 may generate a bounding box surrounding a contour zone as a region. The bounding box may be, for example, an Axis-Aligned Bounding Box (AABB). An axis-aligned bounding box may be a smallest rectangle that surrounds a contour zone. The bounding box may be a bounding box other than an axis-aligned bounding box. An area surrounded by a bounding box is an example of a region.

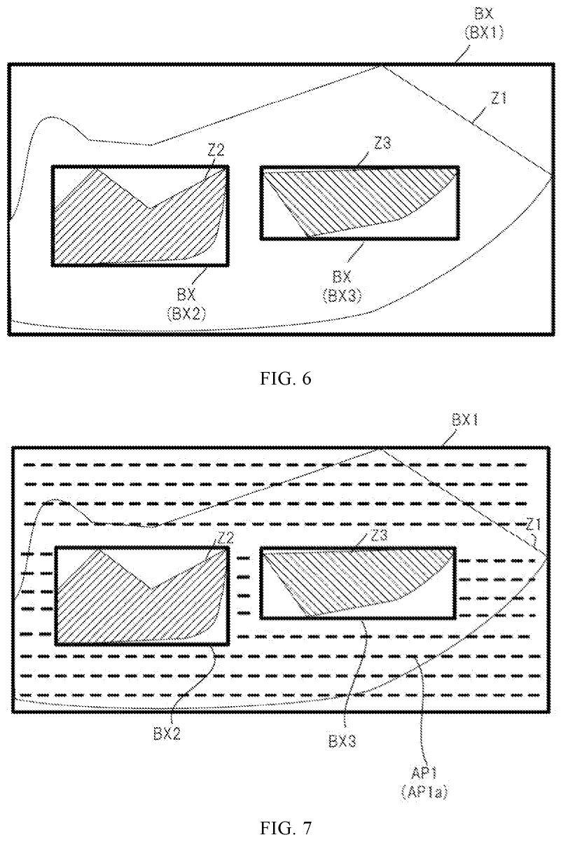

FIG. 6 is a schematic diagram illustrating an example of axis-aligned bounding boxes BX (BX1, BX2, and BX3). FIG. 6 is a view of the ground viewed from the above. FIG. 6 shows an axis-aligned bounding box BX1 that surrounds the contour zone Z1, an axis-aligned bounding box BX2 that surrounds the contour zone Z2, and an axis-aligned bounding box BX3 that surrounds the contour zone Z3. Two orthogonal sides in a rectangle representing an axis-aligned bounding box BX1, BX2, or BX3 are parallel to each other in the axis-aligned bounding boxes BX1 to BX3.

The terminal control unit 81 generates an aerial photography path AP1 (APla, AP1b, AP1c, . . . ) in each axis-aligned bounding box BX. That is, the terminal control unit 81 may generate an aerial photography path AP1 in each region surrounded by, for example, an axis-aligned bounding box BX. The aerial photography path AP1 includes one or more aerial photography positions. The aerial photography path AP1 may be generated by a known method. The aerial photography positions may be generated by a known method. The aerial photography path AP1 may be, for example, an aerial photography path that performs aerial photography in a scanning manner. An aerial photography path that performs aerial photography in another manner may also be considered. The aerial photography positions may be generated in the aerial photography path AP1 by arranging these positions with equal space intervals. Apparently, a plurality of aerial photography positions may not necessarily be arranged with equal space intervals, but rather at different space intervals. The aerial photography path AP1 is an example of a first aerial photography path. In addition, the aerial photography path generation may also be simply referred to as “path generation”.

The scanning method is a method for capturing aerial photographs along a specified direction. Specifically, the scanning method is a method of repeatedly performing the following operations. The operations include first capturing aerial photographs in a specified direction (e.g., the left-right direction in FIG. 7). After reaching an edge of the aerial photography area A1, shift to a position in a direction (e.g., the up and down direction in FIG. 7) orthogonal to the specified direction. Then, continue to capture aerial photographs in the specified direction. Other methods may include, for example, a method of capturing aerial photographs in an aerial photography path that is optimized by combining the terrain information.

The terminal control unit 81 may generate an aerial photography path AP1 without changing the flying height or the aerial photography parameters in each BX. In some embodiments, the terminal control unit 81 may also frequently change the flying height or the aerial photography parameters in each BX, but the image quality change needs to be set to a specified amount or less, to avoid a significant change in image quality. Therefore, the terminal control unit 81 may acquire, for example, the flying height or aerial photography parameters as fixed values (no value change) in each BX.

The terminal control unit 81 may sequentially generate an aerial photography path AP1 in the aerial photography area A1, beginning from the axis-aligned bounding box BX1 located on the outermost. At this moment, the terminal control unit 81 may exclude the axis-aligned bounding boxes BX2 and BX3 located inside the BX1 during the path generation for the axis-aligned bounding box BX1 located on the outer side.

In one aerial photography area A1, the outermost axis-aligned bounding box BX1 is a region having the lowest height. For other axis-aligned bounding boxes BX, the inner the BX, the greater the height. For example, one such height relationship may be found in a scenario of an entire mountain. In another aerial photography area A1, the outermost axis-aligned bounding box BX1 is a region having the greatest height. For other the axis-aligned bounding boxes BX, the inner the BX, the lower the height. For example, one such height relationship may be found in a scenario of a mountain near a crater or a volcanic crater.

FIG. 7 is a schematic diagram illustrating a first example of an aerial photography path AP1 in an axis-aligned bounding box BX. FIG. 7 is a view of the ground viewed from above. In FIG. 7, an aerial photography path AP1 (AP1a) is generated in the axis-aligned bounding box BX1 in a scanning manner. For example, the terminal control unit 81 linearly generates a path from an end (e.g., a lower end) in the axis-aligned bounding box BX1 along a specified direction (e.g., a left-right direction). When reaching an end (e.g., a left end or right end), shift in an orthogonal direction (e.g., the up-down direction) orthogonal to the specified direction, and then linearly continue the path again along the specified direction. Further, when the generated path reaches the edge of the axis-aligned bounding box BX2 (e.g., the right side of the axis-aligned bounding box BX2) along the specified direction, the terminal control unit 81 interrupts the generation of the aerial photography path APla, and does not generate the aerial photography path AP1a of the axis-aligned bounding box BX1 in the axis-aligned bounding box BX2. After that, move along the axis-aligned bounding box BX2 in the specified direction. When the other edge of the axis-aligned bounding box BX2 is reached (e.g., the left side of the axis-aligned bounding box BX2), the terminal control unit 81 resumes generating the aerial photography path AP1a again, and linearly continues the path for the axis-aligned bounding box BX1 in the specified direction.

Further, the point at which the generated path reaches the edge of the axis-aligned bounding box BX2 for the first time may also be referred to as an exclusion start point. The point at which the generated path reaches the edge of the axis-aligned bounding box BX2 for the second time may also be referred to as the exclusion end point. Similarly, the above process is not just applied to the axis-aligned bounding box BX2, but may also be applied to the axis-aligned bounding box BX3.

In the aerial photography area A1, the terminal control unit 81 may generate paths in the axis-aligned bounding boxes BX2 and BX3 located on the inner side after the path generation in the axis-aligned bounding boxes BX1 located on the outer side is completed. In such conditions, the terminal control unit 81 may determine the scanning direction in each inner axis-aligned bounding box BX. For example, the terminal control unit 81 may rotate the scanning directions of the axis-aligned bounding boxes BX2 and BX3 located on the inner side by 90 degrees when compared to the scanning direction of the axis-aligned bounding box BX1 located on the outer side. In this way, the scanning direction of the aerial photography path AP1a in the outer axis-aligned bounding box BX1 is perpendicular to the scanning directions of the aerial photography paths AP1b and AP1c in the inner axis-aligned bounding boxes BX2 and BX3. In some embodiments, the scanning direction may be the same without necessarily a change among the plurality of axis-aligned bounding boxes BX1 to BX3.

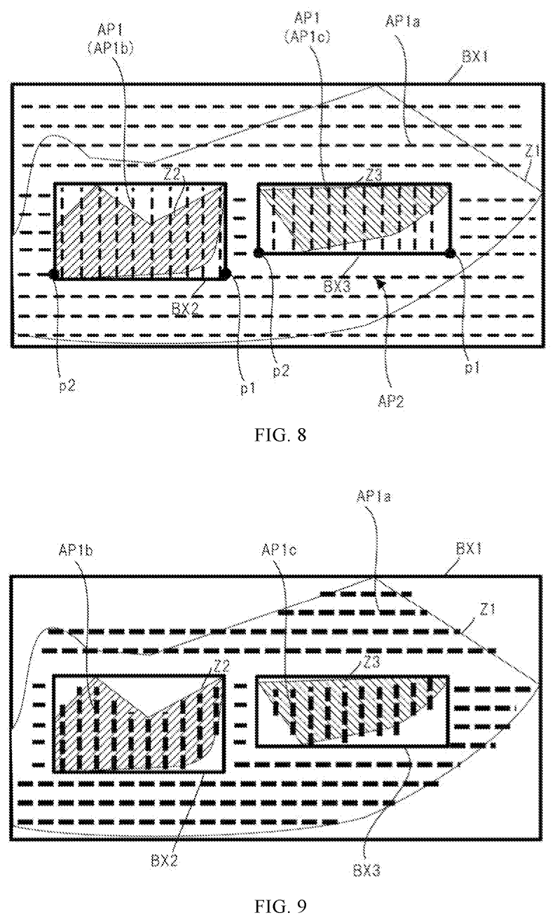

FIG. 8 is a schematic diagram illustrating the first example of the aerial photography path AP1 in the axis-aligned bounding box BX. FIG. 8 is a view obtained by viewing the ground from above. In FIG. 8, an aerial photography path AP1 (AP1a to AP1c) is generated in a scanning manner. In FIG. 8, the paths in the axis-aligned bounding boxes BX2 and BX3 may be generated after the path in the axis-aligned bounding box BX1 is generated. Path generation in the axis-aligned bounding box BX3 may be performed before or after the path generation in the axis-aligned bounding box BX2, or simultaneously with the path generation in the axis-aligned bounding box BX2. In FIG. 8, the scanning direction (i.e., left-right direction) of the aerial photography path AP1a in the axis-aligned bounding box BX1 and the scanning directions (i.e., up-down direction) of the aerial photography paths AP1b and AP1c in the axis-aligned bounding boxes BX2 and BX3 have a 90-degree difference.

The terminal control unit 81 connects the aerial photography paths AP1a to AP1c generated in each of the axis-aligned bounding boxes BX1 to BX3, and generates an overall aerial photography path AP2 for capturing aerial photographs in the entire aerial photography area A1. When the terminal control unit 81 connects the aerial photography path AP1a in the axis-aligned bounding box BX1 with the aerial photography path AP1b in the axis-aligned bounding box BX2, the terminal control unit 81 may set the exclusion start point pl of the aerial photography path AP1a in the axis-aligned bounding box BX1 as the start point of the aerial photography path AP1b in the axis-aligned bounding box BX2, and set the exclusion end point p2 of the aerial photography path AP1a in the axis-aligned bounding box BX1 as the end point of the aerial photography path AP1b in the axis-aligned bounding box BX2. The same applies to the aerial photography path AP1c in the axis-aligned bounding box BX3. The aerial photography path AP2 is an example of a second aerial photography path.

In addition, in the aerial photography path AP2, the exclusion start point pl of the aerial photography path AP1a in the axis-aligned bounding box BX1 and the start point of the aerial photography path AP1b in the axis-aligned bounding box BX2 have different heights but the same two-dimensional (i.e., latitude and longitude) position. Similarly, in the aerial photography path AP2, the exclusion end point p2 of the aerial photography path AP1a in the axis-aligned bounding box BX1 and the end point of the aerial photography path AP1b in the axis-aligned bounding box BX2 have different heights but the same two-dimensional (i.e., latitude and longitude) position. Therefore, as an aerial photographing position in the aerial photographing path AP2, the two points, at which the exclusion start point pl of the aerial photographing path AP1a in the axis-aligned bounding box BX1 and the start point of the aerial photographing path AP1b in the axis-aligned bounding box BX2 are located, may be not both configured as an aerial photography position, but rather one aerial photography position is omitted from the aerial photographing path AP2. Similarly, as an aerial photography position in the aerial photography path AP2, the two points at which the exclusion end point p2 of the aerial photographing path AP1a in the axis-aligned bounding box BX1 and the end point of the aerial photographing path AP1b in the axis-aligned bounding box BX2 are located may not be both configured as an aerial photography position, but rather one aerial photography position is omitted from the aerial photographing path AP2. The reason for such processing is that when the UAV 100 photographs the ground in the air at both aerial photographing positions, the UAV may capture photographs associated with a same location.

In this way, the terminal 80 sequentially generates the aerial photography paths AP1 starting from the outer axis-aligned bounding box BX1 among the plurality of axis-aligned bounding boxes BX in the aerial photography area A1. That is, the path generation starts from the wider axis-aligned bounding box BX1 to generate the aerial photography path APla, and then generates the aerial photography paths AP1b and AP1c in narrower inner axis-aligned bounding boxes BX2 and BX3. Therefore, both the terminal 80 and a user may easily recognize the continuity of the aerial photography paths AP1 among the outer axis-aligned bounding box BX1 and the inner axis-aligned bounding boxes BX2 and BX3.

In addition, the terminal 80 may use the exclusion start point p1 (an example of the first point) and the exclusion end point p2 (an example of the second point) of the axis-aligned bounding box BX1, where the aerial photography path AP1a in the axis-aligned bounding box BX1 meets the axis-aligned bounding boxes BX2 and BX3 inside the axis-aligned bounding box BX1, as the two ends (start and end points) of the aerial photography paths AP1b and AP1c in the axis-aligned bounding boxes BX2 and BX3, to generate the aerial photography paths AP lb and AP1c of the axis-aligned bounding boxes BX2 and BX3. As a result, at the exclusion start points pl in the axis-aligned bounding box BX1, the start points in the axis-aligned bounding boxes BX2, BX3, the exclusion end points p2 in the axis-aligned bounding box BX1, and the end points in the axis-aligned bounding boxes BX2, BX3, the aerial photography path AP1 may be continuously connected. Therefore, the aerial photography paths AP1 may be connected like a stroke. This then allows the terrain with different heights in the aerial photography area A1 to be aerially photographed in one flight.

Further, the terminal 80 makes the scanning direction differ by 90 degrees between the axis-aligned bounding box BX1 and the axis-aligned bounding box BX2, so that it becomes easier to connect the exclusion start point pl with the start point of the aerial photography path AP1b and the exclusion end point p2 with the end point of the aerial photography path AP1b, when compared with the scanning directions being the same direction. Therefore, it is possible to prevent the aerial photography efficiency in the aerial photography path AP1b of the axis-aligned bounding box BX2 located inside the axis-aligned bounding box BX1 from being too low, when generating the aerial photography path AP2 in which the aerial photography path AP1 of each region is connected in the aerial photography area A1. If the scanning directions are set to the same direction, the exclusion start point pl and the exclusion end point p2 will be along the scanning direction. The exclusion end point p2 of the axis-aligned bounding box BX1 and the end point of the aerial photography path AP1b of the axis-aligned bounding box BX2 are then not the same. Therefore, the UAV 100 must navigate from the end point of the aerial photography path AP1 of the axis-aligned bounding box BX2 to the exclusion end point p2 of the axis-aligned bounding box BX1, which likely causes unnecessary flight. In contrast, when the axis-aligned bounding box BX1 and the axis-aligned bounding box BX2 differ in the scanning direction by 90 degrees, the terminal 80 may prevent the unnecessary flight, thereby improving the flight efficiency.

In some embodiments, as shown in FIG. 7 and FIG. 8, the terminal control unit 81 may generate an aerial photography path AP1 across an entire axis-aligned bounding box BX. In some embodiments, as shown in FIG. 9, the terminal control unit 81 may generate an aerial photography path AP1 based on the terrain information of the aerial photography area A1.

FIG. 9 is a schematic diagram illustrating a second example of the aerial photography path AP1 in an axis-aligned bounding box BX. FIG. 9 is a view obtained by viewing the ground from above. In FIG. 9, an aerial photography path AP1 (AP1a to AP1c) is generated in a scanning manner. In the figure, instead of generating an aerial photography path AP1 passing through the entire area in an axis-aligned bounding box BX, an aerial photography path AP1 may be generated passing through only a specified area in the axis-aligned bounding box BX. In FIG. 9, aerial photography paths AP1a to AP1c are generated inside the contour zones Z1 to Z3.

Accordingly, the terminal 80 may generate an aerial photography path AP1 only in a specified part corresponding to the terrain, to guide the UAV 100 to fly. For example, the terminal 80 may generate an aerial photography path AP1 that covers only the intricate coastline land. Therefore, when a user desires to aerially photograph land other than the ocean, the terminal 80 may generate the aerial photography paths AP1 and AP2 with high aerial photography efficiency.

Therefore, in some embodiments, the terminal control unit 81 may arrange aerial photography positions in the entire region within the axis-aligned bounding box BX. In other embodiments, the terminal control unit 81 may arrange aerial photography positions based on the terrain information of the aerial photography area A1. In other words, instead of arranging the aerial photography positions in the entire region within an axis-aligned bounding box BX, the aerial photography positions in the aerial photography path AP1 may be arranged only in a specified area within the axis-aligned bounding box BX.

Accordingly, the terminal 80 may be configured to arrange the aerial photography positions only at specified locations according to the terrain. For example, the terminal 80 may arrange aerial photography positions only on intricate coastline land. Therefore, when a user wants to aerially photograph land other than the sea, the terminal 80 may arrange the aerial photography positions in the aerial photography paths AP1 and AP2 in such a way, to improve aerial photography efficiency.

An operation example of the aerial photography path generation system 10 will be described hereinafter.

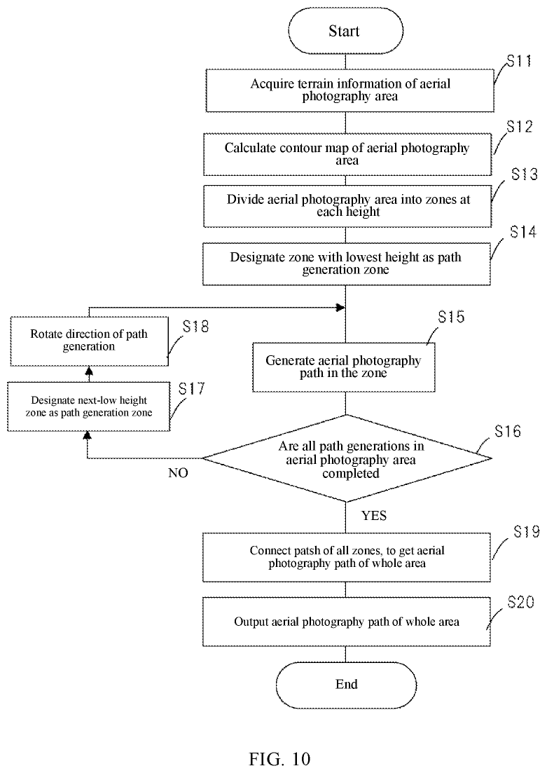

In some embodiments, the operation related to the generation of an aerial photography path is performed by, for example, the terminal 80. FIG. 10 is a flowchart illustrating an operation example for the terminal 80. Here, assume that the outer region has the lowest height in the aerial photography area A1, and the inner the region, the greater the height.

First, the terminal control unit 81 acquires the aerial photography area A1. The terminal control unit 81 then acquires the terrain information of the aerial photography area A1 (S11). The terminal control unit 81 calculates contour lines of the aerial photography area A1 based on the terrain information of the aerial photography area A1, and generates a contour map (S12). The terminal control unit 81 divides the aerial photography area A1 by each height above ground level, in the aerial photography area A1, and then generates a plurality of regions (e.g., axis-aligned bounding boxes BX) (S13).

The terminal control unit 81 sets the lowest-height region (that is, the outermost area) as the path generation region (S14). The path generation region is a region that is a target area for generation of the aerial photography path AP1 in this operation example. The terminal control unit 81 generates an aerial photography path AP1 in the region (i.e., the path generation region) (S15).

The terminal control unit 81 determines whether or not the generation of the aerial photography path AP1 in all the regions (e.g., the axis-aligned bounding boxes BX1 to BX3) in the aerial photography area A1 is completed (S16). When the generation of the aerial photography paths AP1 in the entire aerial photography area A1 has not been completed, the terminal control unit 81 identifies a next low-height region (the next outer region) as the instant path generation region (S17). The terminal control unit 81 rotates the path generation direction (i.e., the scanning direction) of the path generation region set in S17 (S18). In one embodiment, the terminal control unit 81 may rotate the path generation direction by 90 degrees from the scanning direction set for the path generation region in S17. Next, the terminal control unit 81 returns back to the process of S15.

In S16, after the generation of the aerial photography paths AP1 in the entire aerial photography area A1 is completed, the aerial photography path AP1 in each region are connected to generate the aerial photography path AP2 for the entire area (i.e., the aerial photography area A1) (S19).

The terminal control unit 81 outputs information of the aerial photography path AP2 for the entire area (S20). For example, the terminal control unit 81 may transmit the information of the aerial photography path AP2 including the aerial photography positions to the UAV 100 via the communication unit 85. The terminal control unit 81 may use an external storage device (e.g., an SD card) as the storage device 89 to write and record information of the aerial photography path AP2 including the aerial photography positions.

In the UAV 100, the UAV control unit 110 acquires the information of the aerial photography path AP2 output from the terminal 80. For example, the UAV control unit 110 may receive the information of the aerial photography path AP2 via the communication interface 150. The UAV control unit 110 may also acquire the information of the aerial photography path AP2 via an external storage device. Next, the UAV control unit 110 configures the acquired aerial photography path AP2. Specifically, the UAV control unit 110 may store the information of the aerial photography path AP2 in the memory 160 and set the information of the aerial photography path AP2 to a state in which the UAV control unit 110 may implement flight control. As a result, the UAV 100 may fly in accordance with the aerial photography path AP2 generated in the terminal 80 and capture photographs in the air at the aerial photography positions along the aerial photography path AP2. These aerial photographs may be used, for example, for the generation of a composite image or stereo image for the aerial photograph area A1.

Next, the generation of an aerial photography path in a comparative example is compared with the generation of an aerial photography path in the present disclosure.

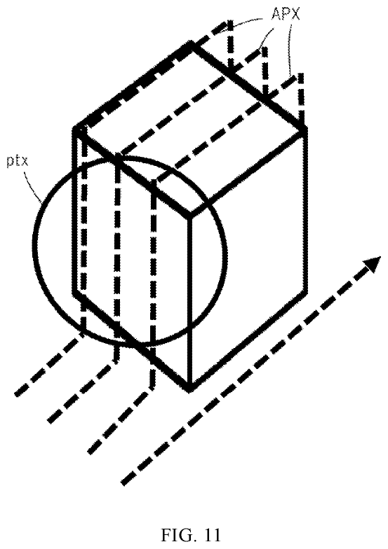

As a comparative example, in order to improve the image quality of an aerial photograph of an object having different heights, the distance between each part of the object having different heights and a UVA is fixed. For example, the UAV generates a flight path that changes the height of the UAV in accordance with the height above ground level for an object, and performs aerial photography. FIG. 11 is a schematic diagram illustrating that the aerial photography height frequently changes along the aerial photography path in the comparative example. FIG. 11 illustrates a situation in which the height of the UAV 100 becomes higher each time after it goes through the part “ptx” with an increasing height on the route of the linear aerial photography path “APX”. In this situation, since the flying height of the UAV is frequently changed, the flight time of the UAV becomes longer, and the energy consumption for the flight of the UAV becomes larger.

Furthermore, in the comparative example, when capturing aerial photographs using the UAV, a transmitter for controlling the UAV is used to instruct the UAV to change the height of the UAV based on the height above ground level for an object. At this moment, the transmitter must be monitored, resulting in an increased workload for a user who monitors the transmitter.

In addition, in the comparative example, it is assumed that a target area to be aerially photographed is manually divided into a plurality of regions based on a user's instruction, and in each of the divided regions, aerial photography is performed through a fixed path set in advance. In this situation, in order to divide the target area, the user must give an instruction via the operation unit. That is, a manual operation by the user is necessary, which also increases the workload of the user.

On the other hand, according to the operation example of the terminal 80, since an aerial photography path AP1 is generated in each region, the aerial photography paths AP1 in each area may be generated by region. Therefore, there is no requirement to frequently change the aerial photography height during the flight. Accordingly, the terminal 80 may prevent the height of the UAV 100 from frequently rising or falling in accordance with the height above ground level. Therefore, the terminal 80 may prevent the frequent change of the flying height of the UAV 100, thereby shortening the flying time of the UAV 100 and reducing the energy consumption of the UAV 100 in flight.

In addition, the terminal 80 does not need to instruct the UAV to change the height of the UAV 100 according to the height above the ground level. Accordingly, the low image quality may be prevented without increasing the workload of the users of the terminal 80 and the transmitter 50 in the aerial photography of a terrain with different heights (such as a staircase area).

Further, since the terminal 80 divides the aerial photography area A1 based on the terrain information of the aerial photography area A1, there is no need for the terminal 80 to receive a user instruction through the operation unit 83 to divide the aerial photography area A1 (a target area where the aerial photography is to be performed). Therefore, the manual operation for a user to divide the aerial photography area A1 is not required. The low image quality may then be prevented without increasing the workload of the users of the terminal 80 and the transmitter 50 in the aerial photography of a terrain with different heights.

Further, since the terminal 80 may prevent low-quality photographs captured in the air in capturing the terrain with different heights, the terminal 80 may prevent low image quality of a composite image or a stereo image generated based on the obtained multiple aerial photographs. In addition, the terminal 80 may prevent a decrease in the distance accuracy for a distance photograph generated based on the obtained plurality of aerial photographs.

Further, the terminal 80 may set the aerial photography positions and the aerial photography path AP2 in the UAV 100 by transmitting the information of the aerial photography path AP2 including the aerial photography positions to the UAV 100. This then allows the UAV 100 to fly along the aerial photography path AP2 generated by the terminal 80 and capture photographs in the air at the aerial photography positions.

In some embodiments, the aerial photography path generation in the present disclosure may be performed by the UAV 100. For this purpose, the UAV control unit 110 of the UAV 100 may have the same function as the relevant function of the aerial photography path generation that the terminal control unit 81 of the terminal 80 has. The UAV control unit 110 is an example of such a processing unit. The UAV control unit 110 performs processing related to the generation of an aerial photography path. It should be noted that, among the processes performed by the UAV control unit 110 related to the aerial photography path generation, the description for the same processes as those performed by the terminal control unit 81 regarding the aerial photography path generation is not specifically repeated here.

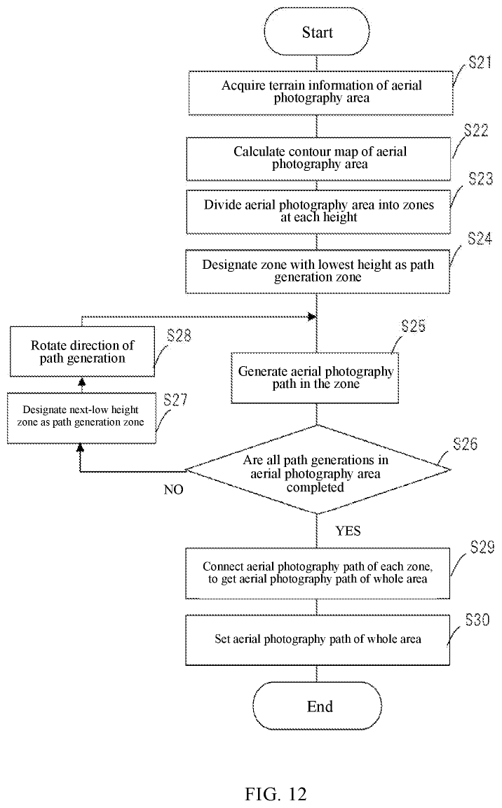

FIG. 12 is a flowchart showing an operation example of the UAV 100. Here, assume that the outer region has the lowest height in the aerial photography area A1, and the inner the region, the greater the height.

First, the UAV control unit 110 acquires the aerial photography area A1. The UAV control unit 110 then acquires the terrain information of the aerial photography area A1 (S21). The UAV control unit 110 calculates contour lines of the aerial photography area A1 based on the terrain information of the aerial photography area A1, and generates a contour map (S22). The UAV control unit 110 divides the aerial photography area A1 at each height above ground level in the aerial photography area A1, and divides the area into a plurality of regions (e.g., axis-aligned bounding boxes BX) (S23).

The UAV control unit 110 designates a region having the lowest height (that is, the outermost region) as a path generation region (S24). In this operation example, the path generation region is a region that is a target area for generation of the aerial photography path API. The UAV control unit 110 generates an aerial photography path AP1 in the region (path generation region) (S25).

The UAV control unit 110 determines whether or not the generation of the aerial photography paths AP1 in all the regions (e.g., the axis-aligned bounding boxes BX1 to BX3) in the aerial photography area A1 is completed (S26). When the generation of the aerial photography paths AP1 in the entire aerial photography area A1 has not been completed, the next low-height region (next outer region) is designated as the path generation region (S27). The UAV control unit 110 rotates the path generation direction (i.e., scanning direction) in the path generation region set in S27 (S28). Specifically, the UAV control unit 110 may rotate the path generation direction by 90 degrees from the scanning direction set for the path generation area in S27. Next, the UAV control unit 110 returns back to the process of S25.

When the generation of the aerial photography paths AP1 in the entire aerial photography area A1 in S26 is completed, the aerial photography path AP1 of each region is connected to generate the aerial photography path AP2 of the entire area (i.e., the aerial photography area A1) (S29).

The UAV control unit 110 sets information of the aerial photography path AP2 for the entire area (S30). Specifically, the UAV control unit 110 stores the generated information of the aerial photography path AP2 in the memory 160, and sets the information of the aerial photography path AP2 including the aerial photography positions to a state in which the UAV controller 110 may implement flight control. As a result, the UAV 100 may fly along the aerial photography path AP2 generated in the UAV 100, and capture photographs in the air at the aerial photography positions along the aerial photography path AP2. These aerial photographs may be used, for example, for generation of a composite image or stereo image for the aerial photograph area A1.

According to the operation example of the UAV 100, since the aerial photography path AP1 is generated in each region, the aerial photography path AP1 may be generated in each area by region. Therefore, there is no necessary to greatly change the aerial photography height. Accordingly, the UAV 100 may prevent the height of the UAV 100 from rising or falling frequently according to the height above ground level. Therefore, the UAV 100 may prevent the flight height change of the UAV 100, thereby shortening the flight time of the UAV 100 and reducing the energy consumption of the UAV 100 in flight.

Further, the UAV 100 does not need instructions to change the height of the UAV 100 according to the height above ground level. Therefore, the low image quality may be prevented without increasing the workload of the users of the terminal 80 and the transmitter 50 when capturing aerial photographs of a terrain with different heights (such as a staircase area).

Further, since the UAV 100 divides the aerial photography area A1 based on the terrain information of the aerial photography area A1, there is no need for the terminal 80 to receive a user instruction through the operation unit 83 to divide the aerial photography area A1 (a target area where the aerial photography is to be performed). Therefore, the manual operation for a user to divide the aerial photography area A1 is not required. The low image quality may then be prevented without increasing the workload of the users of the terminal 80 and the transmitter 50 when capturing aerial photographs of a terrain with different heights

In addition, since the UAV 100 may prevent low-quality photographs captured in the air in capturing the terrain with different heights, the UAV 100 may prevent low image quality of a composite image or a stereo image generated based on the obtained plurality of aerial photographs. In addition, the UAV 100 may prevent a decrease in the distance accuracy for a distance photograph generated based on the obtained plurality of aerial photographs.

In addition, through setting the aerial photography path AP2 including the aerial photography positions, the UAV 100 may fly along the aerial photography path AP2 generated by the UAV 100, and aerially capture photographs at the aerial photography positions. As a result, the UAV 100 may improve the processing accuracy related to processing (such as composite image generation or stereo image generation) of the photographs obtained by aerial photography, thereby improving the image quality of the processed photographs.

In addition, when the aerial photography path generation is performed by the UAV 100, in the terminal 80, the terminal control unit 81 may be configured to assist the processes (e.g., various operations of the operation unit 83 or various display by the display unit 88 in the terminal 80) of the aerial photography path generation by the UAV 100.

For example, in the terminal 80, the terminal control unit 81 may receive an input for designating an aerial photography area A1 via the operation unit 83, and transmit the input information to the UAV 100 via the communication interface 150. The UAV 100 may receive input information for obtaining the designated aerial photography area A1.

For example, in the UAV 100, the UAV control unit 110 may transmit the information of an aerial photography path AP1 or aerial photography path AP2 of the aerial photography area A1 to the terminal 80 via the communication interface 150. In the terminal 80, the terminal control unit 81 may receive the aerial photography path AP1 or the aerial photography path AP2 via the communication unit 85, and make the display unit 88 to display the aerial photography paths AP1 and AP2. The terminal control unit 81 may also display the aerial photography positions on the aerial photography paths AP1 and AP2.

Hereinafter, a modified example of an area for generating an aerial photography path AP1 will be described.

Instead of generating an axis-aligned bounding box BX, the terminal control unit 81 may generate a right-angled polygon frame RP that surrounds a contour zone. A right-angled polygon frame RP is a bounding box having a right-angled polygon periphery. The area surrounded by the right-angled polygon frame RP is an example of a region. A right-angled polygon is also called a rectilinear polygon. A right-angled polygon means that the angle between two adjacent sides of the polygon is a right angle. When the terminal control unit 81 continuously reduces the length of each side of the right-angled polygon in accordance with the shape of the contour zone, the larger the number of sides, the closer the shape of the RP to the contour zone.

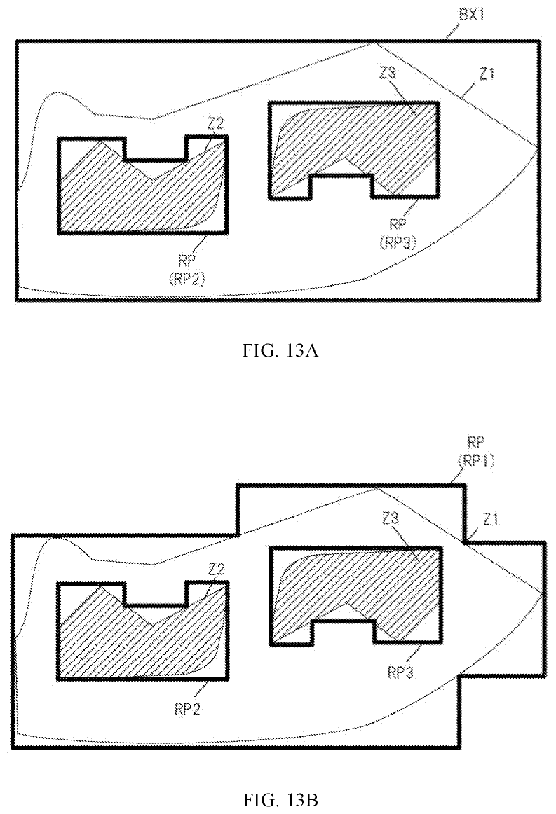

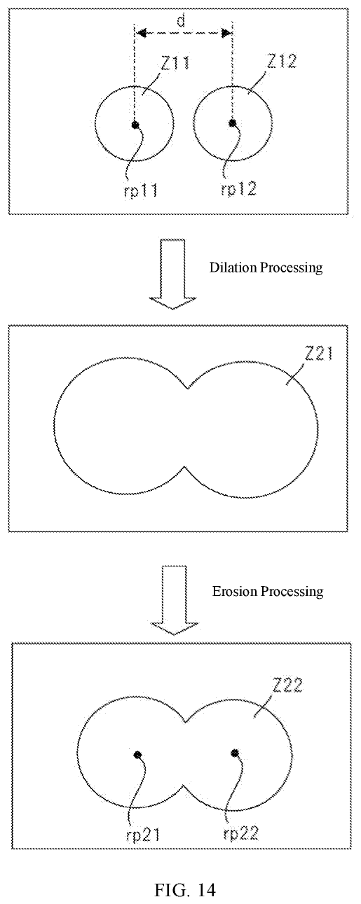

FIG. 13A is a schematic diagram illustrating one example of a right-angled polygon frame RP. FIG. 13B is a schematic diagram illustrating another example of a rectangular polygon frame RP. 13A and 13B are graphs obtained by viewing the ground from above. In FIG. 13A, the outermost contour zone Z1 is surrounded by the axis-aligned bounding box BX1, and the inner contour zones Z2 and Z3 are surrounded by a respective right-angled polygon frame RP (i.e., RP2, RP3). In FIG. 13B, the outermost contour zone Z1 and the inner contour zones Z2 and Z3 are all surrounded by a respective right-angled polygon frame RP (i.e., RP1, RP2, RP3).

The terminal control unit 81 may generate an aerial photography path AP1 in each right-angled polygon frame RP, and connect the aerial photography path AP1 in each right-angled polygon frame RP to generate an aerial photography path AP2 in the aerial photography area A1. When a right-angled polygon frame RP is compared with an axis-aligned bounding box BX, the shape of the enclosing line that surrounds the contour zone is different, but other aspects remain similar.

In this way, the terminal 80 may generate the aerial photography path AP1 of each region by using a right-angled polygon frame RP, and generate an aerial photography path AP1 based on the shape of the periphery of the contour zone, to capture aerial photographs. Accordingly, the imbalance in taking aerial photographs in areas of equal height in real space may be reduced. Furthermore, the terminal 80 may improve the image quality of a composite image or a stereo image based on a plurality of aerial photographs.

On the other hand, if the terminal 80 uses an axis-aligned bounding box BX to generate the aerial photography path AP1 of each region, the terminal 80 does not create discontinuities in the aerial photography path like a right-angled polygon. Therefore, the aerial photography efficiency is good and the aerial photography time may be shortened. For example, when a right-angled polygon frame RP has a concave portion or a convex portion, the aerial photography path AP1 may become discontinuous in the concave portion or the convex portion and some other portions, and thus the flight efficiency may have a certain decrease. If an axis-aligned bounding box BX is used, the possibility of such a reduction in flight efficiency is low, thereby improving the efficiency of aerial photography.

In some embodiments, instead of generating an axis-aligned bounding box BX or a right-angled polygon frame RP, the contour zone itself may be used as a region, and the aerial photography path AP1 may be generated in each contour zone. In this situation, the terminal 80 may generate an aerial photography path AP1 along the actual terrain to capture aerial photographs. Therefore, it is possible to aerially capture photographs of an area having the same height in the real space. Further, the terminal 80 may improve the image quality of a composite image or a stereo image based on a plurality of aerial photographs.

Next, processing of a plurality of contour zones will be described.

When there is a plurality of contour zones having the same height, the terminal control unit 81 may identify the plurality of contour zones as individual regions without checking the distance between the plurality of contour zones (e.g., the contour zones Z2 and Z3 in FIG. 5). In this situation, for each of the individual contour zones, the terminal control unit 81 generates a region for each contour zone, and generates an aerial photography path API for each region.

In some embodiments, when a plurality of contour zones having the same height are close to each other within a distance threshold th2, the terminal control unit 81 may consider them as one contour zone. In this situation, the terminal control unit 81 may recognize a plurality of contour zones having the same height as one contour zone by performing morphological processing. The morphological processing may include dilation processing and erosion processing.

FIG. 14 is a schematic diagram for illustrating the recognition of a plurality of contour zones having the same height as one zone.

In FIG. 14, there are two contour zones Z11 and Z12 having a similar height (e.g., 10 m, 10 m and 15 m, 10-20 m, etc.). The distance between the contour zones Z11 and Z12 is the distance d, which is equal to or less than the threshold th2. At this moment, the terminal control unit 81 performs a dilation processing on the contour zones Z11 and Z12, respectively, to generate one contour zone Z21. Due to the dilation process, the contour zones Z11 and Z12 dilate, and the right end of the contour zone Z11 merges with the left end of the contour zone Z12 to form a new contour zone Z21.

The contour zone Z21 is generated by the dilation of the contour zones Z11 and Z12. Therefore, the overall size of the zone becomes larger than those of the original contour zones Z11 and Z12. Therefore, the terminal control unit 81 performs a reduction process on the contour zone Z21 to get a new contour zone Z22. Due to the reduction process, the size of the contour zone Z21 is reduced. Therefore, the size difference between the contour zone Z22 and the original contour zones Z11 and Z12 may be reduced. The terminal control unit 81 may decrease the size of the contour zone, for example, by keeping the reference positions rp11 and rp12 (e.g., the center positions and the center of gravity positions) of the contour zones Z11 and Z12 to be consistent with the reference positions rp21 and rp22 (e.g., the center positions and the center of gravity positions) of the left part and the right part of the contour zone Z22 corresponding to the contour zones Z11 and Z12.

In this way, the terminal 80 may dilate or erode the two contour zones Z11 and Z12 located near each other, so as to generate one contour zone Z22 without changing the shape or size of the original contour zones Z11 and Z12 really much. As a result, the terminal 80 may merge the two contour zones Z11 and Z12 into one contour zone Z22, and generate a region based on the contour zone Z22, thereby generating an aerial photography path API. Accordingly, when generating the aerial photography path AP1 in each zone, the terminal 80 may generate an axis-aligned bounding box BX or a right-angled polygon frame RP for one contour zone Z22, so that the aerial photography path AP1 is continuously generated in the axis-aligned bounding box BX or right-angled polygon frame RP. In this way, the UAV may continuously fly in the original contour zones Z11 and Z12, and capture aerial photographs at the aerial photography positions of the aerial photography path API. This then improves the aerial photography efficiency when there are a couple of contour zones Z11 and Z12 close to each other.

The present disclosure has been described above in conjunction with specific embodiments. However, the technical scope of the disclosure is not limited to the above description in the disclosed embodiments. It will be apparent to those skilled in the art that various changes or improvements may be made to the foregoing embodiments, or based on the statements in the appended claims, all of which should fall within the technical scope of the present disclosure.

The execution order of each process such as operations, processes, steps, and stages in the devices, systems, programs, and methods shown in the claims, the description, and the drawings may be implemented in other orders, unless there is a specifically defined order, such as “before” and “before”, or unless there is a requirement for an output of a previous processed to be an input of a following process. With respect to the operation flows in the claims, the description, and the drawings, “first”, “next”, etc. are used for convenience, but are not meant to be implemented always in the exact order.

What is claimed is:

1. An information processing apparatus for generating an aerial photography path for aerial photography by an aircraft, comprising:
a processing unit for performing processes related to generating the aerial photography path, the processing unit being configured to:
acquire terrain information of an aerial photography area,
divide the aerial photography area at each height above ground level in the aerial photography area to generate a plurality of zones,
generate a first aerial photography path for aerial photography in each generated zone, and
connect the generated first aerial photography path for each generation zone to generate a second aerial photography path for capturing aerial photographs in the aerial photography area.

2. The information processing apparatus according to claim 1, wherein the processing unit is further configured to:
generate a plurality of contour lines in the aerial photography area based on the terrain information of the aerial photography area; and
generate each of the plurality of zones for each contour zone surrounded by each contour line.

3. The information processing apparatus according to claim 2, wherein the processing unit is further configured to:
generate an axis-aligned bounding box surrounding each contour zone as one of the plurality of zones.

4. The information processing apparatus according to claim 2, wherein the processing unit is further configured to:
generate a right-angled polygon frame surrounding each contour zone as one of the plurality of zones.

5. The information processing apparatus according to claim 1, wherein the processing unit is further configured to:
sequentially generates the first aerial photography path starting from an outer zone among the plurality of zones in the aerial photography area.

6. The information processing apparatus according to claim 1, wherein the processing unit is configured to:
use a first point and a second point, where a first aerial photography path in a first zone of the plurality of zones meets a second zone existing inside the first zone, as two ends of a first aerial photography path in the second zone to generate the first aerial photography path in the second zone.

7. The information processing apparatus according to claim 1, wherein:
the aerial photography path is a path for aerial photography in a scanning manner along a specified direction; and
scanning directions of two first aerial photography paths in two adjacent zones are different by 90 degrees.

8. The information processing apparatus according to claim 1, wherein the processing unit is further configured to:
arrange aerial photography positions on the first aerial photography path based on the terrain information of the aerial photography area.

9. The information processing apparatus according to claim 1, wherein:
the information processing apparatus is a terminal; and
the processing unit transmits information of the second aerial photography path to the aircraft.

10. The information processing apparatus according to claim 1, wherein:
the information processing apparatus is the aircraft; and
the processing unit controls flight in accordance with the generated second aerial photography path.

11. An aerial photography path generation method applied to an information processing apparatus for generating an aerial photography path for aerial photography by an aircraft, comprising:
acquiring terrain information in the aerial photography area;
dividing the aerial photography area at each height above ground level in the aerial photography area to generate a plurality of zones;
generating a first aerial photography path for aerial photography in each of the plurality of zones; and
connecting the first aerial photography path in each of the plurality of zones to generate a second aerial photography path for capturing aerial photographs in the aerial photography area.

12. The aerial photography path generation method according to claim 11, wherein generating the plurality of zones further includes:
generating a plurality of contour lines in the aerial photography area based on the terrain information of the aerial photography area; and
generating each of the plurality of zones for each contour zone surrounded by each contour line.

13. The aerial photography path generation method according to claim 12, wherein generating the plurality of zones further includes:
generating an axis-aligned bounding box surrounding each contour zone as one of the plurality of zones.

14. The aerial photography path generation method according to claim 12, wherein generating the plurality of zones further includes:
generating a right-angled polygon frame surrounding each contour zone as one of the plurality of zones.

15. The aerial photography path generation method according to claim 11, wherein generating the first aerial photography path further includes:
sequentially generating the first aerial photography path starting from an outer zone among the plurality of zones in the aerial photography area.

16. The aerial photography path generation method according to claim 11, wherein generating the first aerial photography path further includes:
using a first point and a second point, where a first aerial photography path in a first zone of the plurality of zones meets a second zone existing inside the first zone, as two ends of a first aerial photography path in the second zone to generate the first aerial photography path in the second zone.

17. The aerial photography path generation method according to claim 11, wherein:
the aerial photography path is a path for aerial photography in a scanning manner along a specified direction; and
scanning directions of two first aerial photography paths in two adjacent zones are different by 90 degrees.

18. The aerial photography path generation method according to claim 11, further comprising:
arranging aerial photography positions on the first aerial photography path based on the terrain information of the aerial photography area.

19. The aerial photography path generation method according to claim 11, wherein:
the information processing apparatus is a terminal; and
the processing unit transmits information of the second aerial photography path to the aircraft.

20. The aerial photography path generation method according to claim 11, wherein:
the information processing apparatus is the aircraft; and
the processing unit controls flight in accordance with the generated second aerial photography path.
